(19) United States
(12) Patent Application Publication
(10) Pub. No.: US 2024/0063914 A1
(43) Pub. Date: Feb. 22, 2024

(54) NETWORK SWITCH SYSTEM

(71) Applicant: Prime World International Holdings Ltd., New Taipei City (TW)

(72) Inventors: Hsiang-Jen LU, New Taipei City (TW); Ming-You LAI, New Taipei City (TW); Che-Shou YEH, New Taipei City (TW)

(21) Appl. No.: 18/386,078

(22) Filed: Nov. 1, 2023

Related U.S. Application Data
(63) Continuation of application No. 16/930,508, filed on Jul. 16, 2020.

(51) Int. Cl. H04B 10/50; H04B 10/278; G02B 6/12; G02B 6/35; H04L 49/351; H04B 10/40; H04Q 11/00

(52) U.S. Cl. CPC H04B 10/503; H04B 10/278; G02B 6/12; G02B 6/3556; H04L 49/351; H04B 10/40; H04Q 11/0003; G02B 2006/12145; H04Q 2011/0052

(57) ABSTRACT

A network switch system includes a switch box and an optical communication device. The optical communication device is at least partially disposed in the switch box. The optical communication device includes a housing, a first light emitter and a ROSA. The first light emitter is disposed in the housing without any ROSA therein. The ROSA is disposed in the switch box and located outside the housing, and the first light emitter is optically coupled to the ROSA.

This application is a continuation patent application of U.S. application Ser. No. 16/930,508, filed on Jul. 16, 2020, the entire contents of which are hereby incorporated by reference.

### BACKGROUND

### 1. Technical Field

The present disclosure relates to a network switch system, more particularly to a network switch system incorporating optical communication sub-systems.

### 2. Related Art

Optical transceivers are generally installed in electronic communication facilities in modern high-speed communication networks. In order to make flexible the design of an electronic communication facility and less burdensome the maintenance of the same, an optical transceiver is inserted into a corresponding cage that is disposed in the communication facility in a pluggable manner. In order to define the electrical-to-mechanical interface of the optical transceiver and the corresponding cage, different form factors such as XFP (10 Gigabit Small Form Factor Pluggable) used in 10 GB/s communication rate, QSFP (Quad Small Form-factor Pluggable), or others at different communication rates have been made available.

The optical communication devices might be implemented in terms on-board optics (OBO) module disposed within the Ethernet switch on basis of consortium for OBO (COBO) technology. A switch box of the Ethernet switch is usually called as distribution box, total switch box, power box, or telecommunication box. The switch box is used to accommodate a switch, a breaker, a measuring instrument, an electric protector, and other auxiliary components. As to the application of optical communication, the switch box further includes fiber terminations and other components which are typically rack-mounted for the purpose of optical fiber distribution.

### SUMMARY

According to one aspect of the present disclosure, a network switch system includes a switch box and an optical communication device. The optical communication device is at least partially disposed in the switch box. The optical communication device includes a housing, a first light emitter and a ROSA. The first light emitter is disposed in the housing without any ROSA therein. The ROSA is disposed in the switch box and located outside the housing, and the first light emitter is optically coupled to the ROSA.

### BRIEF DESCRIPTION OF THE DRAWINGS

The present disclosure will become more fully understood from the detailed description given below and the accompanying drawings which are given by way of illustration only and thus are not intending to limit the present disclosure and wherein:

FIG. 1 is a perspective view of a network switch system according to a first embodiment of the present disclosure;

FIG. 2 is an exploded view of the network switch system in FIG. 1;

FIG. 3 is an exploded view of the optical communication device in FIG. 2;

FIG. 4 is a perspective view of a network switch system according to a second embodiment of the present disclosure;

FIG. 5 is an exploded view of the network switch system in FIG. 4;

FIG. 6 is an exploded view of the optical communication device in FIG. 5;

FIG. 7 is a perspective view of a network switch system according to a third embodiment of the present disclosure;

FIG. 8 is an exploded view of the network switch system in FIG. 7; and

FIG. 9 is an exploded view of the optical communication device in FIG. 8.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

### 1st Embodiment

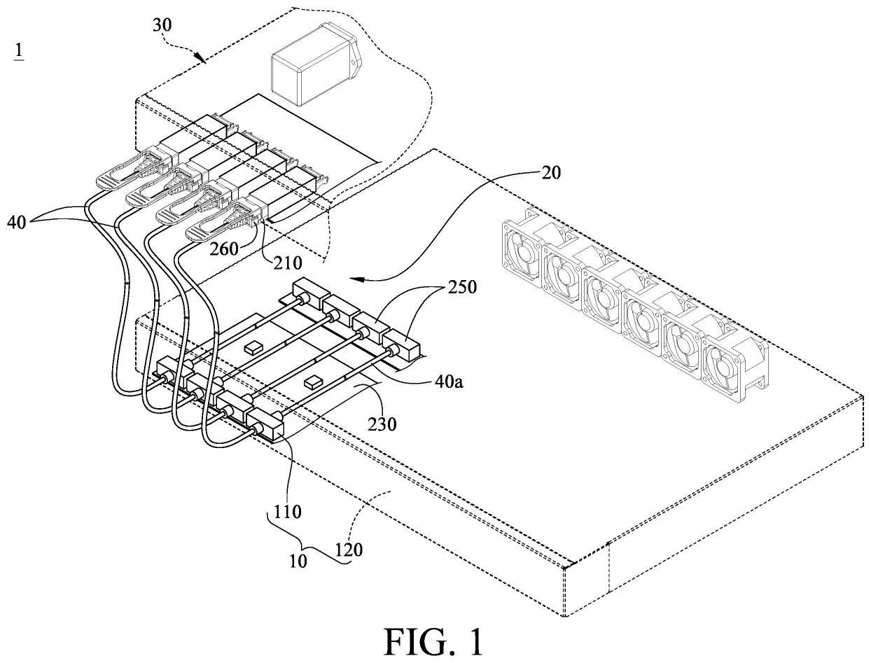

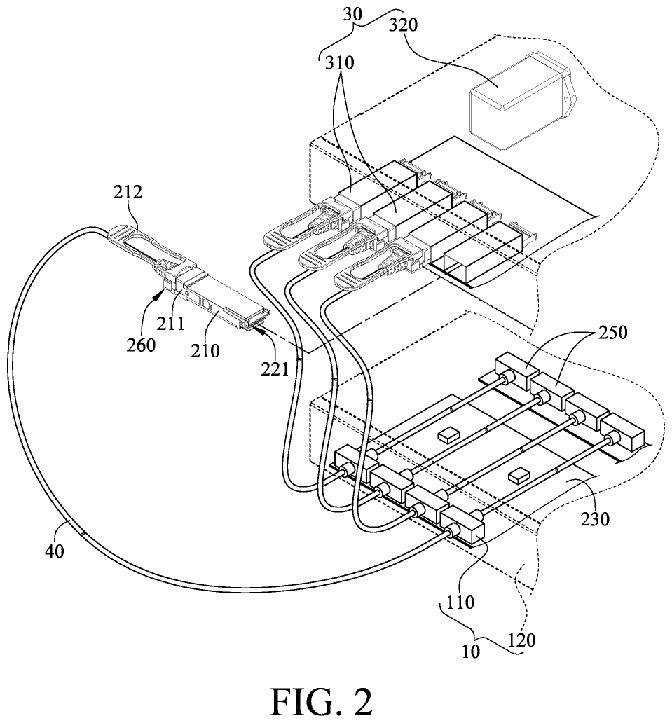

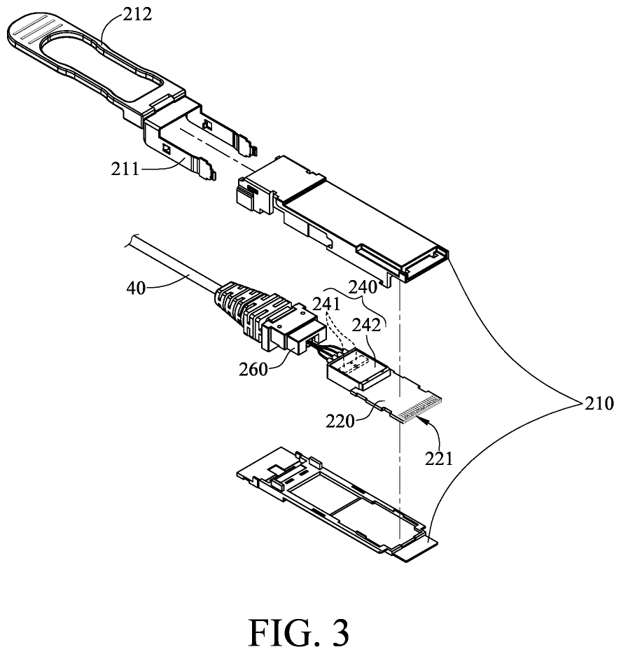

Please refer to FIG. 1 through FIG. 3. FIG. 1 is a perspective view of a network switch system according to a first embodiment of the present disclosure. FIG. 2 is an exploded view of the network switch system in FIG. 1. FIG. 3 is an exploded view of the optical communication device in FIG. 2. In this embodiment, a network switch system 1 includes a switch box 10, a plurality of optical communication devices 20 and a laser source box 30. It is worth noting that the present disclosure is not limited to the number of optical communication devices 20 shown in the drawings.

The switch box 10 is a box of an Ethernet switch including multiple optical adaptors 110 and a casing 120, and the optical adaptor 110 is disposed on the casing 120. Some components, such as switch ASIC (Application Specific Integrated Circuit), micro-controller, power sources, fans and heat transfer fins, might be accommodated in the casing 120.

Each of the optical communication devices 20 includes a housing 210, a transmitter circuit board 220, a receiver circuit board 230, a light emitter set 240 and a ROSA 250. The housing 210 accommodates the transmitter circuit board 220, and the transmitter circuit board 220 has an electrical interface 221. The electrical interface 221 might be gold fingers or metal pads. The receiver circuit board 230 is located outside the housing 210 and disposed in the casing 120 of the switch box 10.

The light emitter set 240 is disposed in the housing 210 and electrically connected to the transmitter circuit board 220. Specifically, the light emitter set 240 includes one or more light emitters 241 and a fiber array 242 optically coupled to each other. The light emitter 241, for example, is a laser diode disposed on the transmitter circuit board 220 and electrically connected to the electrical interface 221 of the transmitter circuit board 220. It is worth noting that the present disclosure is not limited to the number of the light emitters shown in the drawings. The light emitter(s) 241 may be configured to emit the light(s) consistently, with the modulation of the light(s) to be performed outside the housing 210. In another implementation, however, the modulation of the lights is performed within the housing 210. Other components, such as a monitoring photo diode (MPD) and/or an isolator, may be placed within the housing 210 or within the switch box 10. In this embodiment, one or more optical communication components, such as chip, optical fiber (internal optical fiber 40a) or optical lens, are disposed in the casing 120 of the switch box 10.

The ROSA 250 is located outside the housing 210 and disposed in the casing 120 of the switch box 10. The ROSA 250 includes a photodiode configured to receive optical signals and the ROSA 250 might then convert the optical signals into electrical signals. It is worth noting that the present disclosure is not limited to the number of ROSAs 250 shown in the drawings. The ROSA 60 might be implemented within the switch box 10 on basis of COBO technology. The ROSA 250 might be implemented in terms of on-board optics (OBO) module. The receiver circuit board 230 might be where the ROSA 250 is placed. Each optical communication device 20 in this embodiment is provided without a ROSA located in the housing 210. A fiber 40 might be external to the switch box 10 where the ROSA 250 is disposed.

The laser source box 30 includes multiple cages 310 and one or more power supplies 320. The laser source box 30 is located outside the switch box 10. In this embodiment, the optical communication device 20 is detachably disposed on respective cage 310, and the electrical signal interface 221 of the transmitter circuit board 220 is electrically connected to the laser source box 30 in detachable manner. Specifically, the electrical interface 221 can contact a connector (not shown in the drawings) located in the cage 310 and electrically connected to the power supplies 320. Therefore, the light emitter(s) in the laser source box 30 could be powered. In the embodiment that the light emitter set is disposed in the laser source box 30, the power supply 320 might be used to power the light emitter(s) 241.

In some cases, one or more additional components disposed in the housing 210 or the casing 120 of the switch box 10 may be a light modulator. In some other cases, the one or more additional components may be all disposed in the housing 210. In some cases, in the switch box 10, the receiver circuit board 230 can be separated from another circuit board where ROSAs 250 are disposed.

In this embodiment, a fastening component, such as an elastic clip 211 in FIG. 3, might be movably disposed on the side surfaces of the housing 210 so that the housing 210 could be detachably fasten-able with the laser source box 30. Furthermore, a bail 212 might be pivotally connected to the fastening component or the housing 210, and the housing 210 can be removed from the laser source box 30 with the pull of the bail 212.

As shown in FIG. 3, the optical communication device 20 further includes a fiber connector 260, and the ROSA 250 is optically coupled to the fiber connector 260. The fiber connector 260 and the electrical signal interface 221 are located on opposite ends of the transmitter circuit board 220 in this embodiment. The fiber connector 260 is provided to achieve optical coupling between the light emitter set 240 and the ROSA 250. Specifically, the fiber connector 260 is optically coupled to the fiber 40 and the fiber array 242. The optical signal might be transmitted or received through the fiber 40.

The configuration of network switch system 1 provides one or more light sources either implemented in terms of light emitter 241 of the light emitter set 240 or a conventional TOSA, with the light source disposed within the laser source box 30 in detachable manner. The fiber 40 is used to transmit the optical signal to the ROSA 250 in the switch box 10. When one light emitter 241 in the housing 210 fails to function properly, such light emitter 421 can be replaced with a new or backup light emitter from the same laser source box 30.

Moreover, as to a situation that multiple light emitters are in the housing 210, the light emitters 241 are provided with each of them working independently. Specifically, the light emitters 241 can generate lights at the same or similar wavelength and light intensity, and one light emitter 241 is used as default and the other light emitters 241 are prepared for backup components. Generally, the backup light emitters 241 might not be operational when the default one functions. Once the default light emitter 241 is not functional, another light emitter 241 is enabled or activated to take over to ensure the proper operation of the optical communication device 20.

Also, some heat dissipation structures can be disposed on the housing 210 of the optical communication device 20 for dissipating heat generated inside the housing 210, thereby increasing the service life of the light emitter set 240. With certain components accommodated within the housing 210, the space inside the switch box 10 could be further utilized with more flexibility to meet the need of different standards. Meanwhile, the housing 210 might include the light emitter 241 (primary one, and optionally backup ones) with other components. In this alternative embodiment, the ROSA 250 might be effectively placed within the switch box 10. The laser source 30 and the switch box 10 might be placed in the same rack neighboring each other and are optically connected through an external fiber such as the fiber 40.

### 2nd Embodiment

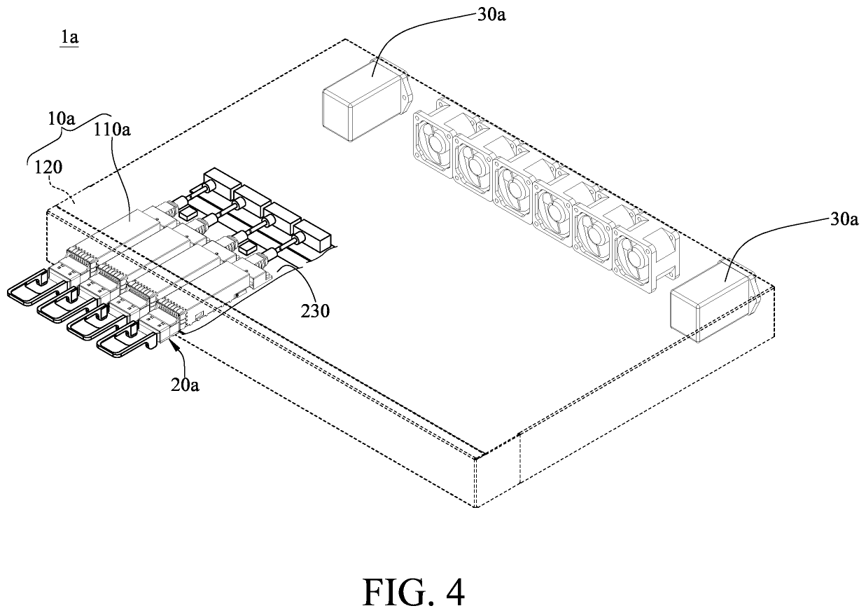

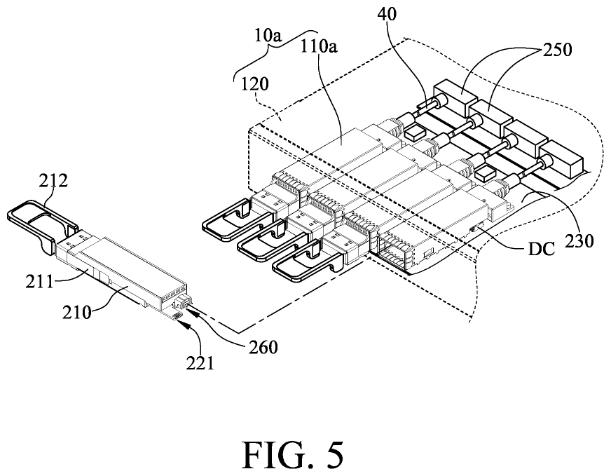

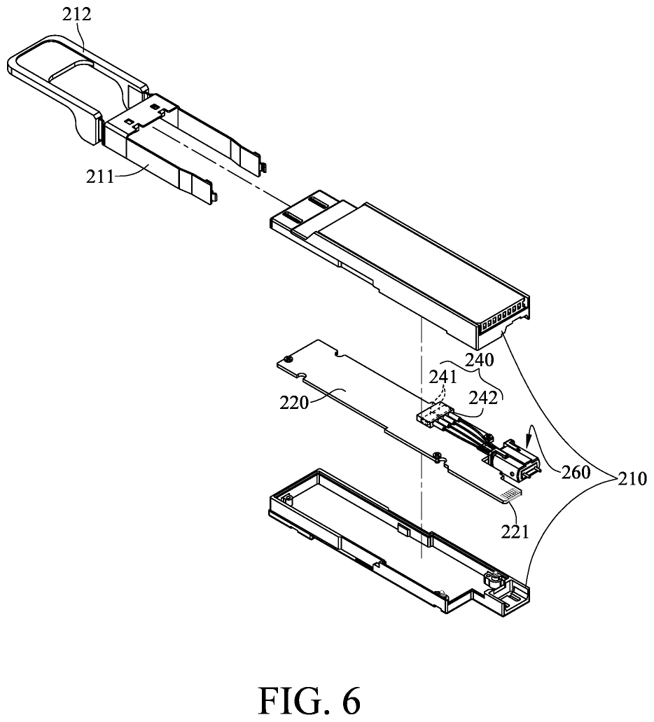

Please refer to FIG. 4 through FIG. 6. FIG. 4 is a perspective view of a network switch system according to a second embodiment of the present disclosure. FIG. 5 is an exploded view of the network switch system in FIG. 4. FIG. 6 is an exploded view of the optical communication device in FIG. 5. In this embodiment, a network switch system 1a includes a switch box 10a, a plurality of optical communication devices 20a and one or more internal power supplies 30a. It is worth noting that the present disclosure is not limited to the number of optical communication devices 20a shown in the drawings.

The switch box 10a includes multiple cages 110a and a casing 120. Some components, such as switch ASIC (Application Specific Integrated Circuit), micro-controller, power sources, fans and heat transfer fins, can be accommodated in the casing 120. The switch box 10a is a box of an Ethernet switch, and the cage 110a might be a connection port of the Ethernet switch allowing for the optical communication device 20a to be plugged into in a detachable fashion.

Each of the optical communication devices 20a includes a housing 210, a transmitter circuit board 220, a receiver circuit board 230, a light emitter set 240 and a ROSA 250. The housing 210 might accommodate the transmitter circuit board 220, and the transmitter circuit board 220 has an electrical interface 221. The electrical interface 221 might be gold fingers or metal pads (not shown in the drawings) connected to a connector (DC) which is connected to the internal power supply 30a.

In this embodiment, a fastening component, such as an elastic clip 211 in FIG. 6, may be movably disposed on side surfaces of the housing 210 so that the housing 210 could be detachably fasten-able with the cage 110a. Furthermore, a bail 212 may be pivotally connected to the fastening component or the housing 210, and the housing 210 can be removed from the cage 110a with the pull of the bail 212.

The light emitter set 240 is disposed in the housing 210 and electrically connected to the transmitter circuit board 220. Specifically, the light emitter set 240 includes one or more light emitters 241 and a fiber array 242 optically coupled to each other. The light emitter 241, for example, is a laser diode disposed on the transmitter circuit board 220 and electrically connected to the electrical interface 221 of the transmitter circuit board 220. It is worth noting that the present disclosure is not limited to the number of the light emitters shown in the drawings. Alternatively, the transmitter circuit board 220 might have the light emitters 241 disposed thereon, with other components for realizing TOSA-related functionality. In this embodiment, one or more optical communication components are disposed in the casing 120 of the switch box 10a.

The ROSA 250 includes a photodiode configured to receive optical signals and the ROSA 250 might then convert the optical signals into electrical signals. It is worth noting that the present disclosure is not limited to the number of ROSAs 250 shown in the drawings. The ROSA 250 might be implemented within the Ethernet switch on basis of COBO technology such as OBO module. The light emitter, whether disposed along with other TOSA components or not, might function as a consistent light source. The ROSA 250 is located outside the housing 210, and the receiver circuit board 230 might be where the ROSA 250 is placed; that is, each optical communication device 20a in this embodiment is provided without a ROSA located in the housing 210.

The internal power supply 30a is located in the casing 120 of the switch box 10. The electrical signal interface 221 of the transmitter circuit board 220 is electrically connected to the internal power supply 30a in detachable manner.

As the optical communication device 20a is disposed on respective cage 110a, the light emitters 241 are placed in the switch box 10a. In some cases, one or more additional components may be disposed in the housing 210 or the casing 120 of the switch box 10a, and said additional component in the casing 120 may be a light modulator. In some other cases, the one or more additional components may be all disposed in the housing 210. Furthermore, the receiver circuit board 230 might be where some components are placed. In some cases, in the switch box 10a, the receiver circuit board 230 can be separated from another circuit board where ROSAs 250 are disposed.

As shown in FIG. 6, the optical communication device 20a further includes a fiber connector 260 disposed on the transmitter circuit board 220, and the ROSA 250 is optically coupled to the fiber connector 260. The fiber connector 260 is provided to achieve optical coupling between the light emitter set 240 and the ROSA 250. Specifically, referring to FIG. 5, a fiber 40 in the switch box 10a might be used to couple the ROSA 250 and the light emitter set 240, and the fiber connector 260 is optically coupled to the fiber 40 and the fiber array 242. The optical signals are transmitted to the ROSA 250 through the fiber connector 260 and the fiber 40. The optical signals, after being converted from their electrical counterparts, might be transmitted to the housing 210 through the fiber connector 260 and the fiber 40. When the light emitters 241 are disposed within the switch box 10a, the fiber 40 might be used to transmit the optical signals to the housing 210 where the light emitters 241 are disposed through the fiber connector 260.

In this embodiment, both the fiber connector 260 and the electrical interface 221 are located on an end of the transmitter circuit board 220. As shown in FIG. 5 and FIG. 6, the electrical interface 221 and the fiber connector 260 are located on the same end of the transmitter circuit board 220 which is relatively close to the fiber 40. This configuration also helps eliminate electromagnetic interference with the components nearby the housing 210.

The configuration of network switch system 1a provides one or more light emitters as the light source, and the housing 210, accommodating the light emitter 241, is disposed on the switch box 10a in detachable manner. In other words, a conventional TOSA might serve as the light source in this embodiment. When the light source with the light emitter fails to function properly, another light emitter could be used as the backup light source. In the case that the light source only contains the light emitters, when one light emitter in the light source fails to function properly, another light emitter could be activated to maintain the proper function of the light source to consistently emit the lights. Also, some heat dissipation structures can be disposed on the housing of the optical communication device 20a for dissipating heat generated by the light emitters to increase the service life.

Moreover, multiple light emitters 241 (laser diodes) generating lights of the same or different wavelengths and light intensity, might be disposed. One light emitter 241 is used as default and the other light emitters 241 are prepared for backup purpose. Generally, the backup light emitters 241 might not be operational when the default one functions. Once the default light emitter 241 is not functional, another light emitter might be enabled or activated to take over to ensure the proper operation of the optical communication device 20a.

### 3rd Embodiment

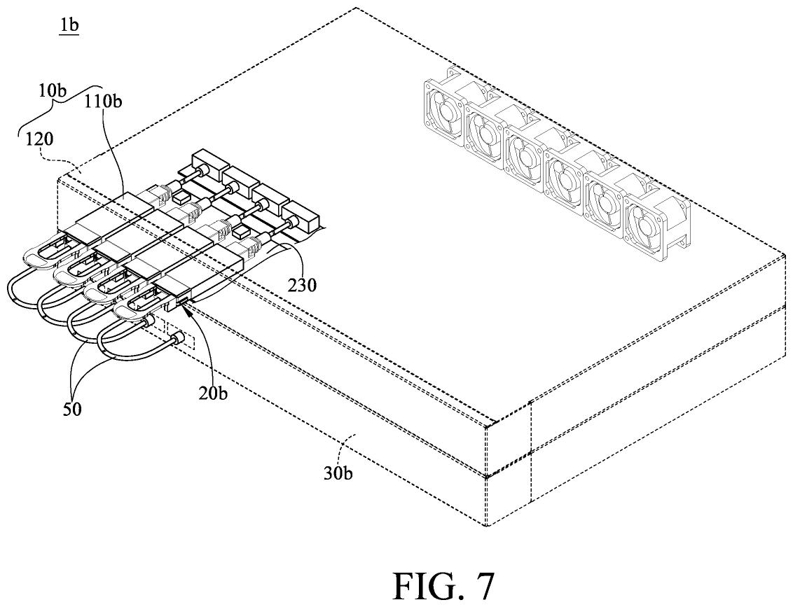

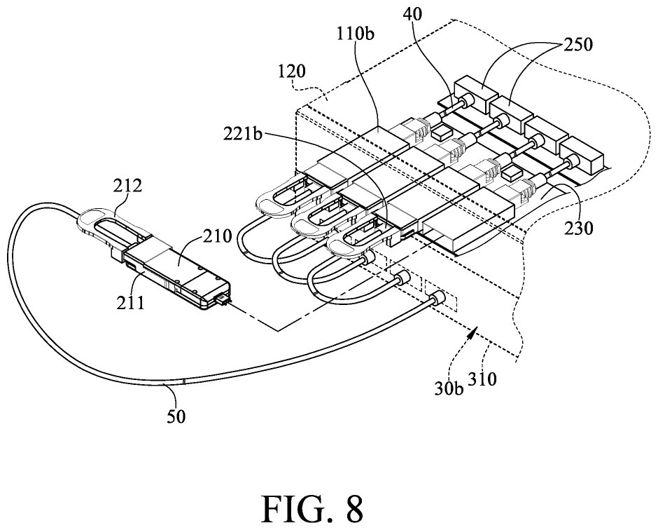

Please refer to FIG. 7 through FIG. 9. FIG. 7 is a perspective view of a network switch system according to a third embodiment of the present disclosure. FIG. 8 is an exploded view of the network switch system in FIG. 7. FIG. 0.9 is an exploded view of the optical communication device in FIG. 8. In this embodiment, a network switch system 1b includes a switch box 10b, a plurality of optical communication devices 20b and an external power supply 30b. It is worth noting that the present disclosure is not limited to the number of optical communication devices 20b shown in the drawings.

The switch box 10b includes multiple cages 110b and a casing 120. The cage 110b is disposed in the casing 120. Some components, such as switch ASIC (Application Specific Integrated Circuit), micro-controller, power sources, fans and heat transfer fins, can be accommodated in the casing 120. The switch box 10b and the external power supply 30b might be in the same rack.

Each of the optical communication devices 20b includes a housing 210, a transmitter circuit board 220, a receiver circuit board 230, a TOSA 240 and a ROSA 250. The transmitter circuit board 220 is disposed in the housing 210, and the transmitter circuit board 220 has an electrical interface 221b. The electrical interface 221b, for example, is a Type-C port or an electrical socket. The housing 210 is connected to the switch box 10b in pluggable manner. Specifically, the housing 210 is detachably inserted into the cage 110b of the switch box 10b. The receiver circuit board 230 is located outside the housing 210 and disposed in the casing 120 of the switch box 10b. The ROSA terms throughout the present disclosure might refer to the conventional definition of ROSA including ROSA-related components.

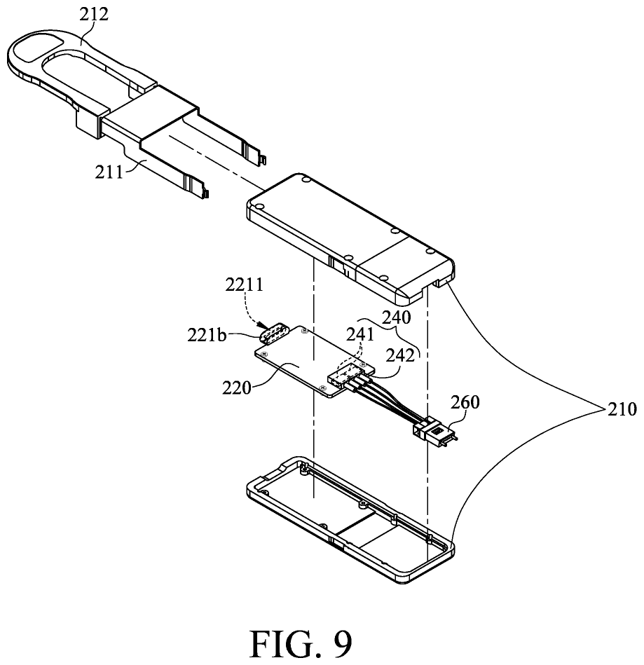

In this embodiment, a fastening component, such as an elastic clip 211 in FIG. 9, can be movably disposed on the outer surface of the housing 210 to be detachably fasten-able with the switch box 10b. Furthermore, a bail 212 can be pivotally connected to the fastening component or the housing 210, and the housing 210 can be removed from the switch box 10b by pulling the bail 212.

The TOSA 240 is disposed in the housing 210 and electrically connected to the transmitter circuit board 220. Specifically, the TOSA 240 includes one or more light emitters 241 and a fiber array 242 optically coupled to each other. The light emitter 241, for example, is a laser diode disposed on the transmitter circuit board 220 and electrically connected to the electrical interface 221b of the transmitter circuit board 220. It is worth noting that the present disclosure is not limited to the number of the light emitter sets 240 shown in the drawings. Also, the TOSA 240 may include additional optical components such as optical lenses or optical fibers in the housing 210. Depending on the design choice, the housing 210 might include the light emitters 241 with other components of the TOSA 240. In this embodiment, one or more optical communication components are disposed in the casing 120 of the switch box 10b.

The ROSA 250 is located outside the housing 210 and disposed in the casing 120 of the switch box 10b. In other words, each optical communication device 20b in this embodiment is provided without a ROSA located in the housing 210. The ROSA 250 includes a photodiode configured to receive optical signals from the TOSA 240 and the ROSA might then convert the optical signals into electrical signals. It is worth noting that the present disclosure is not limited to the number of ROSAs 250 shown in the drawings. The light emitter 241 might serve as laser source optically coupled to the ROSA 250.

The external power supply 30b includes a casing 310 and one or more power sources accommodated in the casing 310. The external power supply 30 is located outside the switch box 10b and the housing 210 of the optical communication device 20b. In this embodiment, the electrical signal interface 221b of the transmitter circuit board 220 is electrically connected to the external power supply 30b. Since the light emitters 241 might be disposed on the transmitter circuit board 220, the connection between the transmitter circuit board 220 and the external power supply 30b to power the light emitters 241. Specifically, the electrical interface 221b might include a receptacle 2211, and a wire 50, electrically connected to the external power supply 30b, is inserted into the receptacle 2211. The ROSA 250 is optically coupled to the light emitters via a fiber 40 in the switch box 10b.

As the optical communication device 20b is disposed on respective cage 110b, the light emitters 241 are effectively placed in the switch box 10b. In some cases, one or more additional components may be disposed in the housing 210 or the casing 120 of the switch box 10b, and said additional component in the casing 120 may be a light modulator. In some other cases, said one or more additional components may be all disposed in the housing 210. In some cases, in the switch box 10b, the receiver circuit board 230 can be separated from another circuit board where ROSAs 250 are disposed.

As shown in FIG. 9, the optical communication device 20b may further include a fiber connector 260 disposed on the transmitter circuit board 220, and the ROSA 250 is optically coupled to the fiber connector 260. The fiber connector 260 is provided to achieve optical coupling between the light emitter 240 and the ROSA 250. The fiber connector 260 might be used to transmit the optical signals to the light emitters 241. Specifically, the fiber connector 260 is optically coupled to the fiber 40 and the fiber array 242. In this embodiment, both the fiber connector 260 and the electrical interface 221b are located on an end of the transmitter circuit board 220. As shown in FIG. 8 and FIG. 9, the electrical interface 221b and the fiber connector 260 are located on the same end of the transmitter circuit board 220 which is relatively close to the fiber 40. Thus, both optical coupling and electrical connection between the TOSA 240/light emitters 241 and the ROSA 250 are achieved without using any jumper, such that an operation of the optical communication device 20b can be simplified. Moreover, since the electrical interface 221b and the fiber connector 260 are located on the same side, it is not necessary to use an external fiber to couple the light emitter set 240. The present disclosure also helps eliminate electromagnetic interference with the components nearby the housing 210.

The configuration of network switch system 1b provides one or more light emitter sets 240 as light source, and the light emitter set 240 is disposed on the switch box 10b in detachable manner. The fiber 40 and the fiber connector 260 are used as optical path between the light emitter set 240 to the ROSA 250 in the switch box 10b. Alternatively, the light emitter set might be placed within the same housing and serving as the light source for the optical communication device 20b, with the fiber 40 and the fiber connector 260 used as the optical path between the light emitters and the ROSA 250.

In this embodiment, multiple light emitter sets 240 might be disposed just in case when the primary light emitter set 240 serving as the light source fails to function properly. Also, multiple light emitters 241 might be disposed to create a backup scheme when one light emitter 241 as the light source fails to function properly.

Also, some heat dissipation structures can be disposed on the housing of the optical communication device 20b for dissipating heat generated by the light emitters 241. The network switch system 1b of the present disclosure could further utilize the space inside the switch box 10b and enhance the design flexibility with at least the light emitters 241 disposed outside the switch box 10b.

According to the present disclosure, the light emitter (or light emitter set) is disposed in a transmitter housing in which there is no any ROSA. In other words, the light emitter and the ROSA are disposed in different housings, respectively. Once the light emitter in the transmitter housing fails to function properly, such light emitter could be replaced with ease by having the transmitter housing opened up. Similarly, the light emitters could be replaced without having the switch box opened up.

The embodiments are chosen and described in order to best explain the principles of the present disclosure and its practical applications, to thereby enable others skilled in the art to best utilize the present disclosure and various embodiments with various modifications as are suited to the particular use being contemplated. It is intended that the scope of the present disclosure is defined by the following claims and their equivalents.

What is claimed is:

1. A network switch system, comprising:
a switch box; and
an optical communication device, at least partially disposed in the switch box, the optical communication device comprising:
a housing;
a first light emitter, disposed in the housing without any ROSA therein; and
a receiver optical subassembly (ROSA), disposed in the switch box and located outside the housing, wherein the first light emitter is optically coupled to the ROSA.

2. The network switch system according to claim 1, further comprising a laser source box, wherein the housing including the first light emitter is disposed in the laser source box in detachable manner, and the first light emitter is located in the laser source box when the housing is inserted into the laser source box.

3. The network switch system according to claim 1, wherein the optical communication device further comprises a circuit board and a fiber connector, the circuit board is disposed in the housing, the circuit board has an electrical signal interface, and the first light emitter and the ROSA are optically coupled to the fiber connector.

4. The network switch system according to claim 3, wherein the electrical signal interface and the fiber connector are located on opposite ends of the circuit board.

5. The network switch system according to claim 3, further comprising an optical fiber connecting the fiber connector and the ROSA, with the optical fiber external to the switch box where the ROSA is disposed.

6. The network switch system according to claim 2, wherein the laser source box is powered by an internal power supply to activate the first light emitter.

7. The network switch system according to claim 1, further comprising a plurality of second light emitters for backup, with each of the first light emitter and the second light emitters working independently.

8. The network switch system according to claim 1, wherein the optical communication device further comprises a circuit board and a fiber connector, the circuit board is disposed in the housing, the circuit board has an electrical signal interface, and the electrical signal interface and the fiber connector are located on a same end of the circuit board.

9. The network switch system according to claim 8, further comprises an internal optical fiber connecting the fiber connector and the ROSA.

10. The network switch system according to claim 8, wherein the housing is inserted into the same switch box where the ROSA is disposed.

11. The network switch system according to claim 8, wherein the TOSA excluding the first light emitter is disposed in the switch box.
